(19) United States
(12) Patent Application Publication
(10) Pub. No.: US 2026/0117582 A1
(43) Pub. Date: Apr. 30, 2026

(54) DOOR LEAF AND DOOR SYSTEM

(71) Applicant: Kingsway Enterprises (UK) Limited, Sidcup (GB)

(72) Inventors: Diggory RUSH, Sidcup (GB); Thomas GILLMORE, Sidcup (GB)

(21) Appl. No.: 18/969,632

(22) Filed: Dec. 5, 2024

(30) Foreign Application Priority Data
Oct. 28, 2024 (GB) 2415825.5

(51) Int. Cl. E06B 3/70; E06B 3/36

(52) U.S. Cl. CPC E06B 3/7007; E06B 3/36

(57) ABSTRACT

A door leaf may include a first straight edge for attachment to a door frame, a second straight edge opposite the first edge, a third straight edge extending between the first and second edges at a first end of the door leaf, and a fourth straight edge extending between the first and second edges at a second end of the door leaf. A door leaf may include a first convexly curved edge, the first convexly curved edge extending from a first intersection point with the second straight edge, to a second intersection point with the third straight edge, wherein each of the third edge and the fourth edge forms an acute angle relative to the first edge.

### RELATED APPLICATION

This application claims priority to Great Brittain Application No. 2415825.5, filed Oct. 28, 2024, the disclosure of which is incorporated herein by reference.

### FIELD

The present disclosure relates to a door leaf, and to a door system comprising the door leaf.

### BACKGROUND

In psychiatric hospitals and prisons, a problem exists that patients and inmates may wish to cause themselves harm using a ligature created by securing a rope or cable around an available anchor point in a room. One solution to this problem is to design room fixtures and fittings such that they do not provide such anchor points. Many bespoke fixtures and fittings exist for psychiatric hospitals and prisons, with this aim in mind. However, suicides in psychiatric hospitals and prisons remain a problem. Patients and inmates continue to find anchor points from which to secure a ligature and cause themselves harm.

One particular problem area is door systems. Door leaves, while necessary to offer privacy to individuals, offer potential anchor points around which ligatures can be secured.

### SUMMARY

A first aspect of the present disclosure is set out in claim 1. A second aspect of the present disclosure is set out in claim 5. A third aspect of the present disclosure is set out in claim 22. Other features of the present disclosure are set out in the dependent claims and in the description below.

### BRIEF DESCRIPTION OF THE DRAWINGS

The present disclosure will now be described, with reference to the accompanying drawings, in which:

FIG. 1 shows a first comparative example of the present disclosure;

FIG. 2 shows a second comparative example of the present disclosure;

FIG. 3 shows an exemplary door leaf according to the present disclosure;

FIG. 4 shows a geometric representation of the door leaf of FIG. 3;

FIG. 5 shows a door system incorporating the door leaf of FIG. 3;

FIG. 6 shows a further exemplary door leaf according to the present disclosure;

FIG. 7 shows a geometric representation of the door leaf of FIG. 6; and

FIG. 8 shows a door system incorporating the door leaf of FIG. 6.

Like reference numerals are used for like components throughout the drawings.

### DETAILED DESCRIPTION

Generally speaking, there is a conflict between the desire for door leaves to offer privacy, and the desire for door leaves to be designed so as to eliminate anchor points for ligatures. Even in the case of washroom (e.g. shower) doors, which may be provided as swing doors to provide privacy, and which do not include locking or latching mechanisms, ligature risks are present. In particular, by looping a ligature around such a washroom door leaf, it may still be possible to obtain a secure enough anchoring of the ligature to commit self-harm.

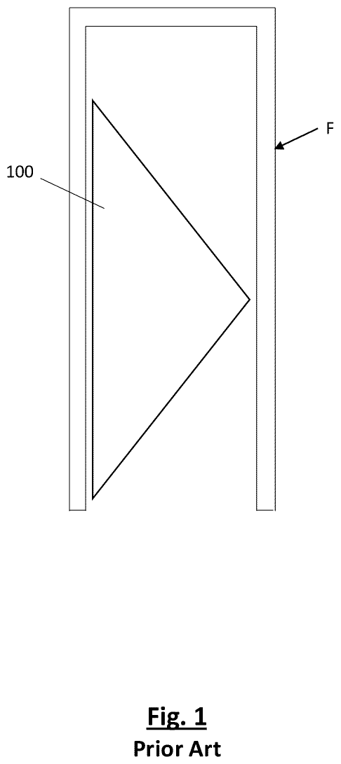

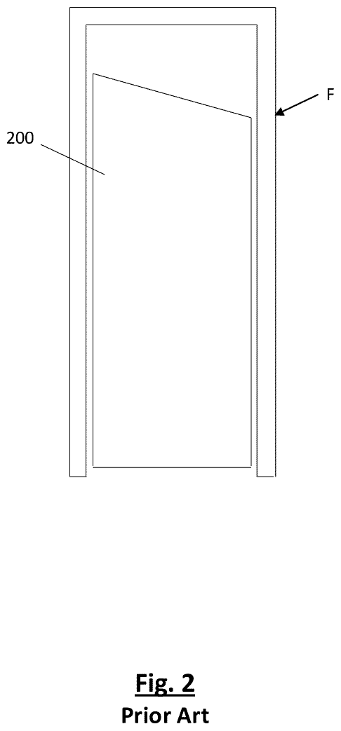

Introducing a steep slope at the top and bottom edges of a door leaf helps to remove ligature points, because a steeper slope will cause a ligature to slide off more readily. However, increasing the slope of the top and bottom edges of a door leaf reduces the privacy offered by the door. A comparative example of a door leaf 100 which is designed to reduce ligature points, but in which the door leaf provides inadequate privacy, is shown in FIG. 1. A further comparative example, this time of a door leaf 200 which provides adequate privacy, but in which the door leaf does not satisfactorily prevent ligature attempts, is shown in FIG. 2. In each of FIGS. 1 and 2, the door leaves are shown mounted in a door frame F.

The inventors have found that there is a delicate balance to be struck on the geometry of a door leaf, in order to ensure that ligature attempts are prevented while at the same time providing adequate privacy. In particular, the top and bottom edges of the door leaf must be sloped sufficiently to prevent the anchoring of ligatures around the door leaf, while at the same time providing adequate privacy.

Disclosed herein are door leaves which are designed to strike the above balance. The door leaves according to the present disclosure therefore provide adequate privacy while effectively preventing ligature attempts.

The door leaves according to the present disclosure will be described as having a first edge, a second edge, a third edge, and a fourth edge. In use, the first edge will the edge which attaches to a hinge, and is therefore in use generally oriented vertically. The second edge will be the closing edge, which opposes the first edge, and in many examples will be parallel with the first edge. The third edge may in use be arranged as the top edge. The fourth edge may in use be arranged as the bottom edge. However, as the reader will understand, the door leaf may be provided as a standalone part for attachment to a hinge or door frame, and so the door leaf may not always be oriented in this way. The first, second, third, and/or fourth edges may be straight.

A first feature of a door leaf according to the present disclosure, is that the bottom edge thereof is sloped (in addition to the top edge being sloped), so as to form an acute angle with respect to the first edge of the door leaf. This ensures that ligatures secured around the bottom edge of the door leaf will be urged to slide off the bottom edge (as well as ligatures secured around the top edge being similarly urged).

A second feature of a door leaf according to the present disclosure is that the slope of the top edge is greater than the slope of the bottom edge. That is to say, an angle between the top edge and the first edge is smaller than an angle between the bottom edge and the first edge. By including this asymmetry, ligatures are preferentially encouraged to slide down the top edge, which in turn increases a horizontal component of the force applied to the ligature at the bottom edge, thereby effectively dragging the ligature along the bottom edge, such that the ligature is caused to slide off the door leaf.

A third feature of a door leaf according to the present disclosure is that the top edge and the closing edge both form tangents with a first circle. The first circle has a focus which coincides with a pivot axis of the door leaf, or which is located distal of the pivot axis from the closing edge. Further, a first convexly curved edge is provided between a first intersection point at which the top edge intersects the first circle and a second intersection point at which the closing edge intersects the first circle. The inventors have found that this combination of features promotes sliding of a ligature from the top edge. In particular, it ensures that a sufficiently large obtuse angle is provided between the top edge and the closing edge, with the first convexly curved profile further promoting sliding off of a ligature. In some further examples, the first convexly curved edge may follow (e.g. extends along) the circumference of the first circle between the first and second intersection points. The first convexly curved edge may therefore comprise an arc of the first circle. In some examples, the bottom edge may also form a tangent of the first circle.

As the reader will understand, where the geometry of a door leaf is described herein with reference to one or more circles, the circle(s) are intended as geometric tools using which the geometries of the door leaf are defined. The circles therefore do not physically exist in the door leaf. The circles may therefore be notional circles, meaning that they are useful for characterising the geometries of the door leaf but do not exist in reality.

A fourth feature of a door leaf according to the present disclosure is that the closing edge comprises a straight edge. This helps to improve privacy, because the straight edge can be arranged to abut a closing edge of a door frame. The top and bottom edges may also be straight to further improve security.

A fifth feature of a door leaf according to the present disclosure is that a first concavely curved edge is provided between the top edge and the first edge, and a second concavely curved edge is provided between the bottom edge and the first edge, wherein a radius of curvature of the first concavely curved edge is different from a radius of curvature of the second concavely curved edge. By providing different radii of curvature between the two concavely curved edges, a ligature may be preferentially kicked from one edge (e.g. the edge having the smaller radius of curvature) before the other edge, thereby causing the edges to apply different horizontal forces on the ligature from one another, such that the edges provide an unstable anchoring, thereby causing the ligature to be kicked from the door leaf.

Where an angle between the top edge and the first edge is smaller than an angle between the bottom edge and the first edge, the first concavely curved edge may have a smaller radius of curvature than the second concavely curved edge. Accordingly, the slope at the top of the door leaf may always be greater than the slope at a vertically aligned point at the bottom of the door leaf, in order to always have an effect of kicking a ligature from the door leaf. In particular, the horizontal component of forces applied to the ligature at each of the top and bottom edges of the door leaf may always be imbalanced, thereby eliminating any stable ligature points.

As the reader will understand, a door leaf according to the present disclosure may include one or more of the first, second, third, fourth and fifth features. Further optional features of door leaves according to the present disclosure are provided below.

The first convexly curved edge may extend along the circumference of the first circle between the first and second intersection points.

A radius of curvature of the first convexly curved edge may be equal to or larger than a perpendicular distance between the second straight edge and a pivot axis of the door leaf.

The fourth straight edge may comprise a tangent of the first circle.

The third straight edge may form a first acute angle with the first edge. The second straight edge may form a second acute angle with the first edge which is larger than the first acute angle.

The radius of curvature of the first concavely curved edge may be smaller than the radius of curvature of the second concavely curved edge.

The door leaf may further comprise a second convexly curved edge. The second convexly curved edge may extend from a fifth intersection point with the second edge to an sixth intersection point with the fourth edge.

There may be no concavely profiled edges between the third straight edge and the second straight edge or between the fourth straight edge and the second straight edge.

A radius of curvature of the second convexly curved edge may be smaller than a radius of curvature of the first convexly curved edge.

The door leaf may be formed of a substantially rigid polymer. The door leaf may be formed of polymethyl methacrylate “PMMA” or polycarbonate. The door leaf may be opaque.

The third edge may form an angle with the first edge of at least 30 degrees, for example at least 40 degrees, such as at least 45 degrees. The third edge may form an angle with the first edge of at most 70 degrees, for example at most 60 degrees, such as at most 55 degrees.

The fourth edge may form an angle with the first edge of at least 55 degrees, for example at least 60 degrees, such as at least 65 degrees. The fourth edge may form an angle with the first edge of at most 85 degrees, for example at most 80 degrees, such as at most 75 degrees.

The fourth straight edge may be longer than the third straight edge.

The second straight edge may be parallel with the first straight edge.

The door leaf may further comprise a clamping surface provided along the first straight edge. The clamping surface may extend from a fifth straight edge at the first end of the door leaf, to a sixth straight edge at the second end of the door leaf. The fifth and sixth straight edges may be oriented perpendicularly to the first edge.

The first concavely curved edge may extend between the third intersection point and the fifth straight edge. The second concavely curved edge may extend between the fourth intersection point and the sixth straight edge.

The pivot axis of the door leaf may extend through the clamping portion. The pivot axis may be oriented parallel with the first edge.

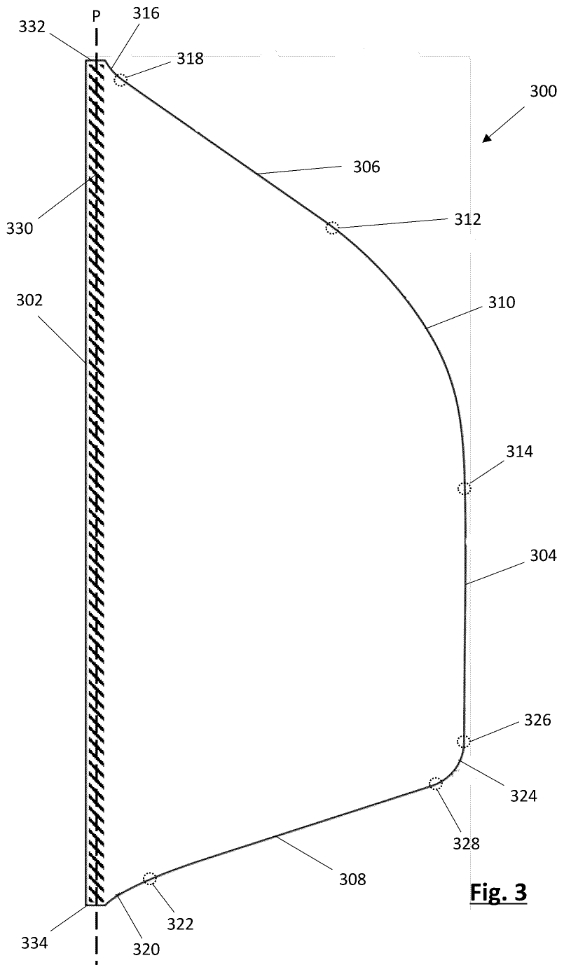

An exemplary door leaf 300 according to the present disclosure is shown in FIG. 3.

As shown, the door leaf 300 includes: a first straight edge 302, which is configured for attachment to a hinge and is generally oriented vertically in use; a second straight edge 304 which is located opposite the first straight edge 302 and is oriented parallel with the first straight edge 302; a third straight edge 306 which in use is located at the top of the door leaf 300; and a fourth straight edge 308 which in use is located at the bottom of the door leaf 300. In some examples, one or more of the second edge 304, third edge 306, and fourth edge 308, may be curved.

The third edge 306 forms a first acute angle with respect to the first edge 302. The fourth edge 308 forms a second acute angle with respect to the first edge 302. The second acute angle is greater than the first acute angle. The first acute angle is roughly 50 degrees in the depicted example. The second acute angle is roughly 70 degrees in the depicted example.

A first convexly curved edge 310 extends between the second edge 304 and the third edge 306. The first convexly curved edge 310 meets the third edge 306 at first intersection point 312. The first convexly curved edge 310 meets the second edge 304 at second intersection point 314.

A first concavely curved edge 316 extends towards the first edge 302 from the third edge 306. The first concavely curved edge 316 meets the third edge 306 at third intersection point 318. Thus, the third edge 306 extends between the first intersection point 312 and the third intersection point 318.

A second concavely curved edge 320 extends towards the first edge 302 from the fourth edge 308. The second concavely curved edge 320 meets the fourth edge 308 at fourth intersection point 322.

A second convexly curved edge 324 extends between the second edge 304 and the fourth edge 308. The second convexly curved edge 324 meets the second edge at fifth intersection point 326. The second convexly curved edge 324 meets the fourth edge 308 at sixth intersection point 328. Thus, the second edge 304 extends between the second intersection point 314 and the fifth intersection point 326. The fourth edge 308 extends between the fourth intersection point 322 and the sixth intersection point 328.

The second convexly curved edge 324 has a smaller radius of curvature than the first convexly curved edge 310. The second concavely curved edge 320 has a larger radius of curvature than the first concavely curved edge 316. The first and second concavely curved edge 316, 320 have respective radii of curvature that are smaller than that of the first convexly curved edge 310.

Provided along the first edge 302 is a clamping region 330, which extends the full length of the door leaf 300, from top to bottom. The clamping region 330 is configured, in use, to be clamped into a pivoting component of a hinge. The clamping region extends between a fifth straight edge 332 and a sixth straight edge 334 of the door leaf 300. The fifth and sixth straight edges 332, 334 are oriented perpendicular with the first edge 302.

The first concavely curved edge 316 extends between the fifth straight edge 332 and the third intersection point 318. The second concavely curved edge 320 extends between the sixth straight edge 334 and the fourth intersection point 322.

The door leaf is formed of a polymer, such as either polymethyl acrylate (“PMMA”) or polycarbonate. It is opaque to provide privacy.

As shown on FIG. 3, pivot axis P of the door leaf extends vertically through the clamping region 330.

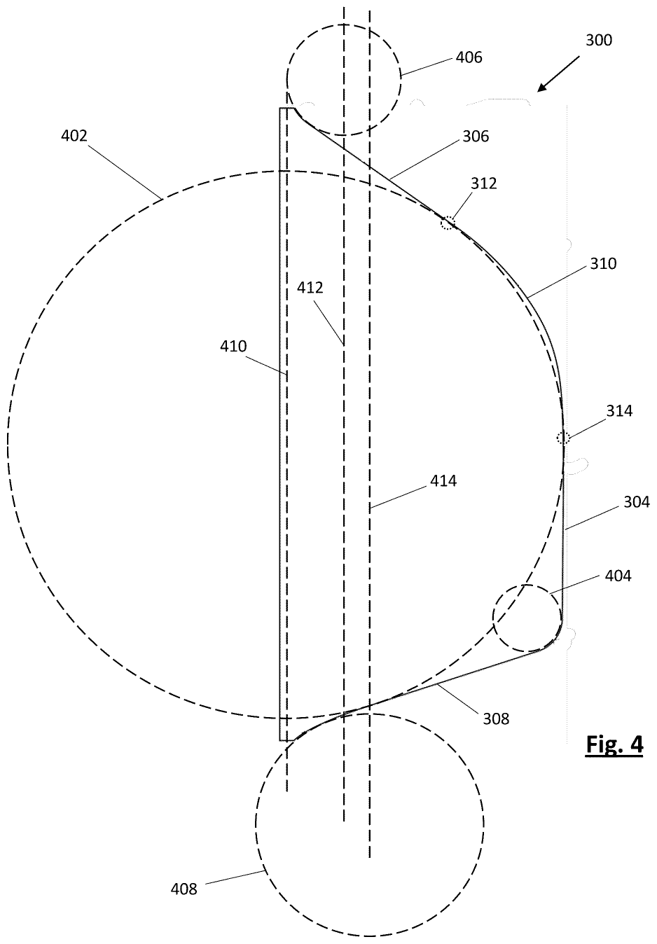

FIG. 4 shows a geometric representation of the door leaf 300, which illustrates the geometry of the door leaf with the use of circles.

Labelled on FIG. 4 are a first circle 402, a second circle 404, a third circle 406, and a fourth circle 408. First circle 402 corresponds to the first convex edge 310; second circle 404 corresponds to the second convex edge 324; third circle 406 corresponds to the first concave edge 316; and fourth circle 408 corresponds to the second concave edge 320. A first vertical line 410 is drawn in FIG. 4 which passes through the focus of the first circle 402; a second vertical line 412 is drawn which passes through the focus of the third circle 406; and a third vertical line 414 is drawn which passes through the focus of the fourth circle 408.

As can be seen from FIG. 4, the second convex edge 324 follows the circumference of the second circle 404 (i.e. comprises an arc of the second circle 404), the first concave edge 316 follows the circumference of the third circle 406 (i.e. comprises an arc of the third circle 406); and the second concave edge 320 follows the circumference of the fourth circle 408 (i.e. comprises an arc of the fourth circle 408). The second convex edge 324 has the smallest radius of curvature; the first convex edge 310 has the largest radius of curvature; and the second concave edge 320 has a radius of curvature that is larger than that of the first concave edge 316.

Because the second concave edge 320 has a larger radius of curvature than that of the first concave edge 316, the focus 412 of the radius of curvature of the first concave edge 316 is closer to the pivot axis P than the focus 414 of the radius of curvature of the second concave edge 320.

As can also be seen on FIG. 4, the focus 410 of the first circle 402 coincides with the pivot axis P. Additionally, each of the second edge 304, the third edge 306, and the fourth edge 308 comprise a tangent of the first circle 402. Moreover, the second edge 304 and the third edge 306 meet the first circle 402 at the respective first and second intersection points 312, 314.

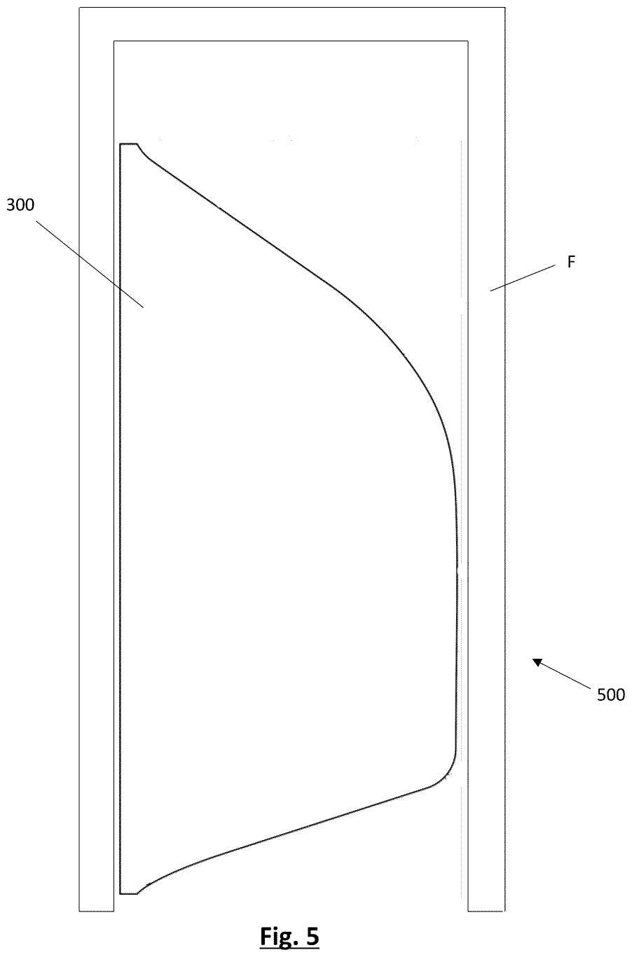

FIG. 5 shows a door system 500 comprising the door leaf 300 pivotally attached to a door frame F.

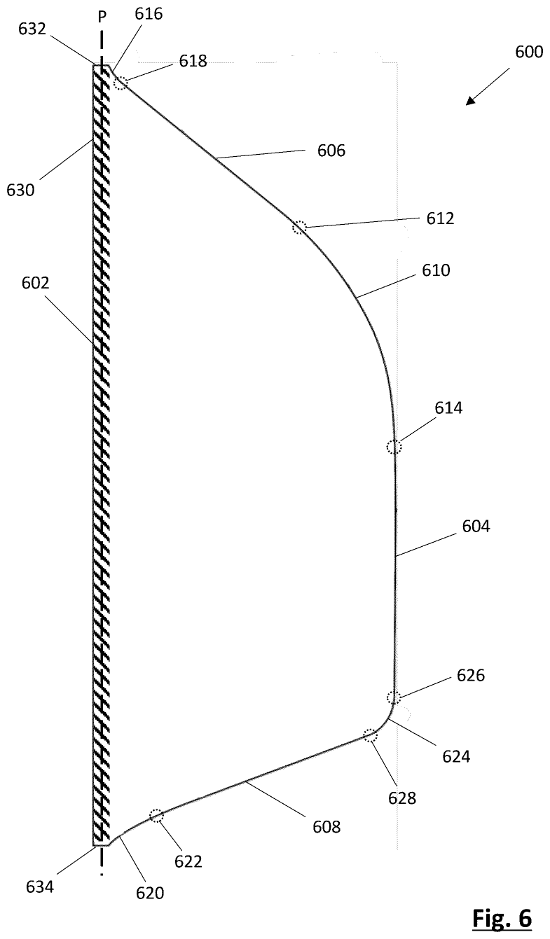

FIG. 6 shows a further exemplary door leaf 600 according to the present disclosure. As will be described below, the door leaf 600 is in almost all respects the same as the door leaf 300. However, as will be seen, the door leaf 600 includes a first convex edge 610 which substantially follows the circumference of the first circle 702, such that the first convex edge 610 comprises an arc of the first circle 702.

As shown, the door leaf 600 includes: a first straight edge 602, which is configured for attachment to a hinge and is generally oriented vertically in use; a second straight edge 604 which is located opposite the first straight edge 602 and is oriented parallel with the first straight edge 602; a third straight edge 606 which in use is located at the top of the door leaf 600; and a fourth straight edge 608 which in use is located at the bottom of the door leaf 600. In some examples, one or more of the second edge 304, third edge 306, and fourth edge 308, may be curved.

The third edge 606 forms a first acute angle with respect to the first edge 602. The fourth edge 608 forms a second acute angle with respect to the first edge 602. The second acute angle is greater than the first acute angle. The first acute angle is roughly 50 degrees in the depicted example. The second acute angle is roughly 70 degrees in the depicted example.

A first convexly curved edge 610 extends between the second edge 604 and the third edge 606. The first convexly curved edge 610 meets the third edge 606 at first intersection point 612. The first convexly curved edge 610 meets the second edge 604 at second intersection point 614.

A first concavely curved edge 616 extends towards the first edge 602 from the third edge 606. The first concavely curved edge 616 meets the third edge 606 at third intersection point 618. Thus, the third edge 606 extends between the first intersection point 612 and the third intersection point 618.

A second concavely curved edge 620 extends towards the first edge 602 from the fourth edge 608. The second concavely curved edge 620 meets the fourth edge 608 at fourth intersection point 622.

A second convexly curved edge 624 extends between the second edge 604 and the fourth edge 608. The second convexly curved edge 624 meets the second edge at fifth intersection point 626. The second convexly curved edge 624 meets the fourth edge 608 at sixth intersection point 628. Thus, the second edge 604 extends between the second intersection point 614 and the fifth intersection point 626. The fourth edge 608 extends between the fourth intersection point 622 and the sixth intersection point 628.

The second convexly curved edge 624 has a smaller radius of curvature than the first convexly curved edge 610. The second concavely curved edge 620 has a larger radius of curvature than the first concavely curved edge 616. The first and second concavely curved edges 616, 620 have respective radii of curvature that are smaller than that of the first convexly curved edge 610.

Provided along the first edge 602 is a clamping region 630, which extends the full length of the door leaf 600, from top to bottom. The clamping region 630 is configured, in use, to be clamped into a pivoting component of a hinge. The clamping region extends between a fifth straight edge 632 and a sixth straight edge 634 of the door leaf 600. The fifth and sixth straight edges 632, 634 are oriented perpendicular with the first edge 602.

The first concavely curved edge 616 extends between the fifth straight edge 632 and the third intersection point 618. The second concavely curved edge 620 extends between the sixth straight edge 634 and the fourth intersection point 622.

The door leaf is formed of a polymer, such as either polymethyl acrylate (“PMMA”) or polycarbonate. It is opaque to provide privacy.

As shown on FIG. 6, pivot axis P of the door leaf extends vertically through the clamping region 630.

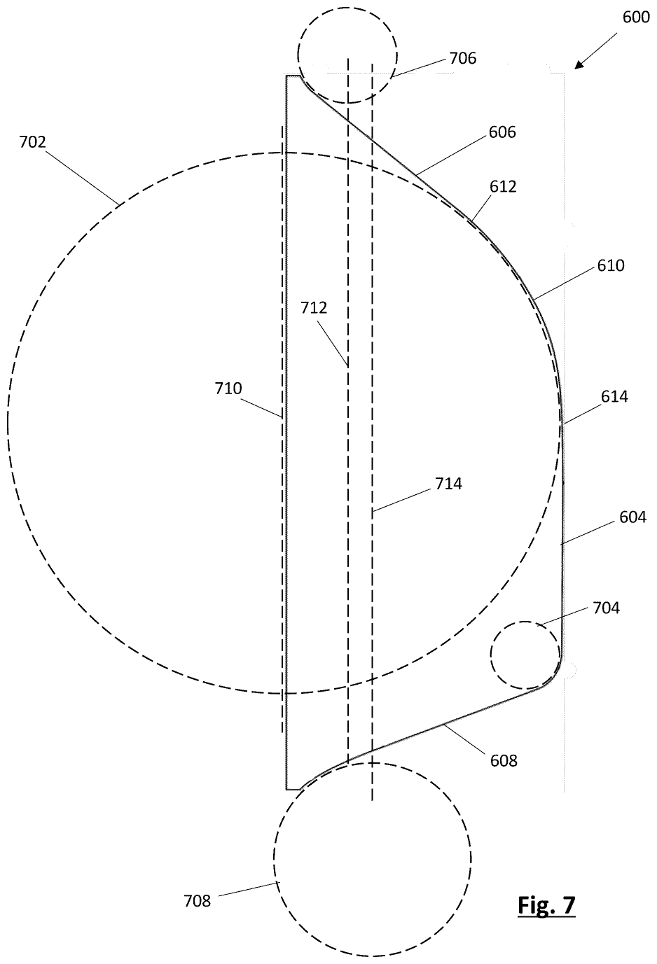

FIG. 7 shows a geometric representation of the door leaf 600, which illustrates the geometry of the door leaf with the use of circles.

Labelled on FIG. 7 are a first circle 702, a second circle 704, a third circle 706, and a fourth circle 708. First circle 702 corresponds to the first convex edge 610; second circle 704 corresponds to the second convex edge 624; third circle 706 corresponds to the first concave edge 616; and fourth circle 708 corresponds to the second concave edge 620. A first vertical line 710 is drawn in FIG. 7 which passes through the focus of the first circle 702; a second vertical line 712 is drawn which passes through the focus of the third circle 706; and a third vertical line ; 714 is drawn which passes through the focus of the fourth circle 708.

As can be seen from FIG. 7, the first convex edge 610 substantially follows the circumference of the first circle 702 (i.e. comprises an arc of the first circle 702), the second convex edge 624 follows the circumference of the second circle 704 (i.e. comprises an arc of the second circle 704), the first concave edge 616 follows the circumference of the third circle 706 (i.e. comprises an arc of the third circle 706); and the second concave edge 620 follows the circumference of the fourth circle 708 (i.e. comprises an arc of the fourth circle 708). The second convex edge 624 has the smallest radius of curvature; the first convex edge 610 has the largest radius of curvature; and the second concave edge 620 has a radius of curvature that is larger than that of the first concave edge 616.

Because the second concave edge 620 has a larger radius of curvature than that of the first concave edge 616, the focus 712 of the radius of curvature of the first concave edge is closer to the pivot axis P than the focus 714 of the second concave edge 620.

As can also be seen on FIG. 7, the focus 710 of the first circle 702 is located distal of the pivot axis P, relative to the second edge 604. Additionally, each of the second edge 604, the third edge 606, and the fourth edge 608 comprise a tangent of the first circle 702. Moreover, the second edge 604 and the third edge 606 meet the first circle 702 at the respective first and second intersection points 612, 614.

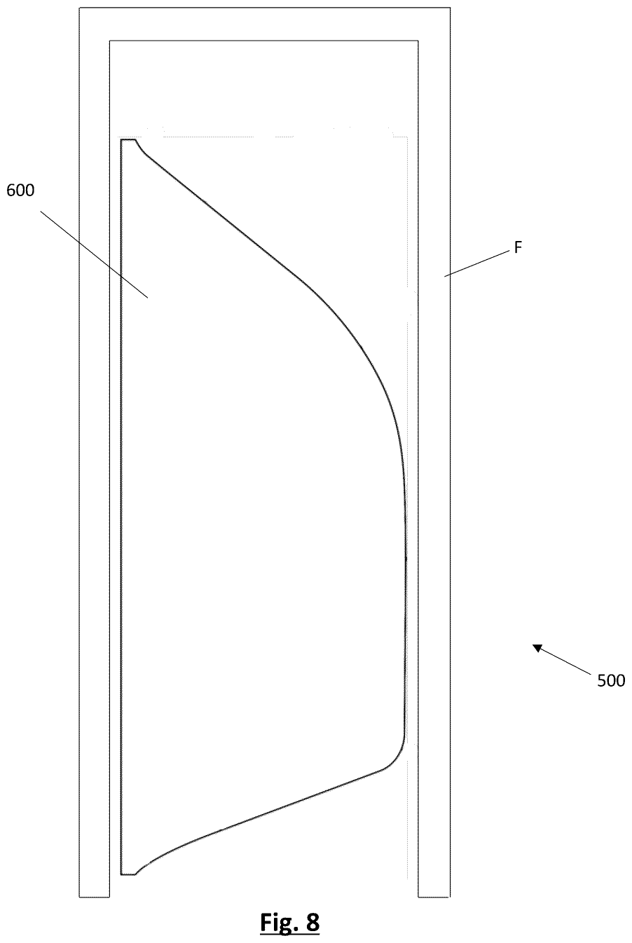

FIG. 8 shows a door system 800 comprising the door leaf 400 and a door frame F.

Further examples of the present disclosure are provided in the following itemised paragraphs.
1. A door leaf comprising:
   a first straight edge for attachment to a door frame, a second straight edge opposite the first edge, a third edge (e.g. third straight edge) extending between the first and second edges at a first end of the door leaf, and a fourth edge (e.g. fourth straight edge) extending between the first and second edges at a second end of the door leaf; and
   a first convexly curved edge, the first convexly curved edge extending from a first intersection point with the second straight edge, to a second intersection point with the third straight edge;
   wherein each of the third edge and the fourth edge forms an acute angle relative to the first edge.
2. The door leaf of item 1, wherein the third edge forms a first angle with the first edge and the fourth edge forms a second angle with the first edge, wherein the first angle is smaller than the second angle.
3. The door leaf of item 1 or item 2, wherein the second straight edge and the third straight edge are arranged such that the second straight edge forms a tangent to a fist circle at the first intersection point, and such that the third straight edge forms a tangent to the first circle at the second intersection point, wherein the focus of the first circle coincides with a pivot axis of the door leaf, or is located distal of the pivot axis from the second and third edges.
4. The door leaf of item 3, wherein the first convexly curved edge extends along the circumference of the first circle between the first and second intersection points.
5. The door leaf of item 3 or item 4, wherein a radius of curvature of the first convexly curved edge is equal to or larger than a perpendicular distance between the second straight edge and a pivot axis of the door leaf.
6. The door leaf according to any of items 3 to 5, wherein the fourth straight edge comprises a tangent of the first circle.
7. The door leaf of any preceding item, further comprising:
   a first concavely curved edge, the first concavely curved edge extending towards the first edge from a third intersection point with the third straight edge; and
   a second concavely curved edge, the second concavely curved edge extending towards the first edge from a fourth intersection point with the fourth straight edge.
8. The door leaf of item 7, wherein a radius of curvature of the first concavely curved edge is different from a radius of curvature of the second concavely curved edge.
9. The door leaf of item 8, wherein the first concavely curved edge has a radius of curvature that is less than that of the second concavely curved edge.
10. The door leaf of any preceding item, further comprising:
   a second convexly curved edge, the second convexly curved edge extending from a fifth intersection point with the second edge to an sixth intersection point with the fourth edge.
11 The door leaf of item 10, wherein a radius of curvature of the second convexly curved edge is smaller than a radius of curvature of the first convexly curved edge.
12. The door leaf of any preceding item, wherein the door leaf is formed of a substantially rigid polymer.
13. The door leaf of item 12, wherein the door leaf is formed of polymethyl methacrylate “PMMA”or polycarbonate.
14. The door leaf of any preceding item, wherein the door leaf is opaque.
15. The door leaf of any preceding item, wherein the third edge forms an angle of between 30-70 degrees with the first edge, for example 40-60 degrees with the first edge, such as between 45-55 degrees with the first edge.
16. The door leaf of any preceding item, wherein the fourth edge forms an angle of between 55-85 degrees with the first edge, for example 60-80 degrees with the first edge, such as between 65-75 degrees with the first edge.
17. The door leaf of any preceding item, wherein the fourth straight edge is longer than the third straight edge.
18. The door leaf of any preceding item, wherein the second straight edge is parallel with the first straight edge.
19. The door leaf of any preceding item, further comprising a clamping surface provided along the first edge.
20. The door leaf of item 19, wherein the clamping surface extends from a fifth straight edge at the first end of the door leaf, to a sixth straight edge at the second end of the door leaf, wherein the fifth and sixth straight edges are oriented perpendicularly to the first edge.
21. The door leaf of item 20 when dependent on item 7, wherein the first concavely curved edge extends between the third intersection point and the fifth straight edge; and wherein the second concavely curved edge extends between the fourth intersection point and the sixth straight edge.
22. The door leaf according to any of items 19 to 21, wherein the pivot axis of the door leaf extends through the clamping portion, and is oriented parallel with the first edge.
23. A door system comprising a door leaf according to any preceding item, and a door hinge, wherein the first edge of the door leaf is pivotally attached to the door hinge.
24. The door system of item 23, wherein the first edge of the door leaf is clamped within a pivoting component of the door hinge.

It is to be understood that the above description is intended to be illustrative, and not restrictive. Many other implementations will be apparent to those of skill in the art upon reading and understanding the above description. Although the present disclosure has been described with reference to a specific example implementation, it will be recognized that the disclosure is not limited to the implementations described, but can be practiced with modification and alteration insofar as such modification(s) and alteration(s) remain within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A door leaf, comprising:
a first edge for attachment to a door frame, a second edge opposite the first edge, a third edge extending between the first and second edges at a first end of the door leaf, and a fourth edge extending between the first and second edges at a second end of the door leaf.
wherein the first edge, the second edge, and the fourth edge are straight, and the third edge is curved; and
a convexly curved edge, the convexly curved edge extending from a first intersection point with the second edge, to a second intersection point with the third edge;
wherein each of the third edge and the fourth edge forms an acute angle relative to the first edge; and
wherein the second edge and the third edge are arranged such that the second edge forms a tangent to a circle at the first intersection point, and such that the third edge forms a tangent to the circle at the second intersection point,
wherein at least one of the focus of the circle coincides with a pivot axis of the door leaf, or the focus of the circle is located distal of the pivot axis from the second edge.

2. The door leaf of claim 1, wherein the convexly curved edge extends along the circumference of the circle between the first intersection point and the second intersection point.

3. The door leaf of claim 1, wherein a radius of curvature of the convexly curved edge is equal to or larger than a perpendicular distance between the second edge and the pivot axis of the door leaf.

4. The door leaf of claim 1, wherein the fourth edge comprises a tangent of the circle.

5. A door leaf, comprising:
a first edge for attachment to a door frame, a second edge opposite from the first edge, a third edge extending between the first and second edges at a first end of the door leaf, and a fourth edge extending between the first and second edges at a second end of the door leaf.
wherein the first edge, the second edge, and the fourth edge are straight, and the third edge is curved;
a convexly curved edge, the convexly curved edge extending from a first intersection point with the second edge, to a second intersection point with the third edge;
a first concavely curved edge, the first concavely curved edge extending towards the first edge from a third intersection point with the third edge; and
a second concavely curved edge, the second concavely curved edge extending towards the first edge from a fourth intersection point with the fourth edge;
wherein each of the third edge and the fourth edge forms an acute angle with the first edge; and
wherein a radius of curvature of the first concavely curved edge is different from a radius of curvature of the second concavely curved edge.

6. The door leaf of claim 5, wherein the third edge forms a first acute angle with the first edge, and wherein the second edge forms a second acute angle with the first edge which is larger than the first acute angle,
wherein the acute angle is the first acute angle.

7. The door leaf of claim 6, wherein the radius of curvature of the first concavely curved edge is smaller than the radius of curvature of the second concavely curved edge.

8. The door leaf of claim 5,
wherein the second edge and the third edge are arranged such that the second edge forms a tangent to a circle at the first intersection point, and such that the third edge forms a tangent to the circle at the second intersection point,
wherein at least one of the focus of the circle coincides with a pivot axis of the door leaf, or the focus of the circle is located distal of the pivot axis from the second edge and the third edge.

9. The door leaf of claim 5, further comprising a second convexly curved edge, the second convexly curved edge extending from a fifth intersection point with the second edge to a sixth intersection point with the fourth edge,
wherein the convexly curved edge is a first convexly curved edge.

10. The door leaf of claim 9, wherein a radius of curvature of the second convexly curved edge is smaller than a radius of curvature of the first convexly curved edge.

11. The door leaf of claim 5, wherein the third edge forms the acute angle of between 30-70 degrees with the first edge.

12. The door leaf of claim 5, wherein the fourth edge forms the acute angle of between 55-85 degrees with the first edge.

13. The door leaf of claim 5, wherein the fourth edge is longer than the third edge.

14. The door leaf of claim 5, wherein the second edge is parallel with the first edge.

15. The door leaf of claim 5, further comprising a clamping surface provided along the first edge.

16. The door leaf of claim 15, wherein the clamping surface extends from a fifth edge at the first end of the door leaf, to a sixth edge at the second end of the door leaf, wherein the fifth and sixth edges are oriented perpendicularly to the first edge.
wherein the fifth edge and the sixth edge are straight.

17. The door leaf of claim 16, wherein the first concavely curved edge extends between the third intersection point and the fifth edge; and wherein the second concavely curved edge extends between the fourth intersection point and the sixth edge.

18. The door leaf of claim 15, wherein a pivot axis of the door leaf extends through a clamping portion, and is oriented parallel with the first edge.

19. A door system, comprising:
a door leaf comprising:
a first edge for attachment to a door frame, a second edge opposite the first edge, a third edge extending between the first and second edges at a first end of the door leaf, and a fourth edge extending between the first and second edges at a second end of the door leaf.
wherein the first edge, the second edge, and the fourth edge are straight, and the third edge is curved; and
a convexly curved edge, the convexly curved edge extending from a first intersection point with the second edge, to a second intersection point with the third edge;
wherein each of the third edge and the fourth edge forms an acute angle relative to the first edge; and
wherein the second edge and the third edge are arranged such that the second edge forms a tangent to a circle at the first intersection point, and such that the third edge forms a tangent to the circle at the second intersection point,
wherein at least one of the focus of the circle coincides with a pivot axis of the door leaf, or the focus of the circle is located distal of the pivot axis from the second and third edges; and
a door hinge, wherein the first edge of the door leaf is pivotally attached to the door hinge.

20. The door system of claim 19, wherein the first edge of the door leaf is clamped within a pivoting component of the door hinge.
